(19) United States
(12) Patent Application Publication
(10) Pub. No.: US 2024/0181690 A1
(43) Pub. Date: Jun. 6, 2024

(54) INJECTION MOLDING CONTROL DEVICE

(71) Applicant: FANUC CORPORATION, Yamanashi (JP)

(72) Inventors: Hironori KUSAKABE, Yamanashi (JP); Junpei MARUYAMA, Yamanashi (JP); Masaya TAJIKA, Yamanashi (JP)

(73) Assignee: FANUC CORPORATION, Yamanashi (JP)

(21) Appl. No.: 18/553,517

(22) PCT Filed: Jun. 17, 2021
(86) PCT No.: PCT/JP2021/023070

§ 371 Date: Sep. 29, 2023

(51) Int. Cl. B29C 45/76

(52) U.S. Cl. CPC B29C 45/76; B29C 2045/7606; B29C 2945/76859

(57) ABSTRACT

Provided is an injection molding control device with which an operator can simply change display content. An injection molding control device according to an aspect of the present disclosure is an injection molding control device, which controls an injection molding operation of an injection molding machine, comprising: a touch panel; a storage unit which stores data collected in the injection molding machine; and a display control unit which displays, on the touch panel, a graph of a portion of the data extracted from the storage unit, and changes display content of the graph in response to a touch operation on the touch panel, wherein the display control unit changes display content of the graph to different content according to a case where the touch operation is a prescribed gesture operation through a single touch and a case where the touch operation is the gesture operation through multiple touches.

### TECHNICAL FIELD

The present invention relates to an injection molding control device.

### BACKGROUND ART

In an injection molding machine, injection molding is controlled using various types of collected data such as a screw position, a rotation speed, a torque, and an injection pressure. Thus, in some cases, in the injection molding machine, a graph showing a change in part of the data in association with, e.g., a time or a screw position is displayed so that an operator can easily grasp the state of injection molding.

Patent Document 1 describes such a technique that in addition to display of injection molding data by a graph on the monitor, an operation of changing each displayed content such as a data item of the graph, the range of an axis of the graph, and a cursor position on the graph is assigned to a function key in order for an operator to easily change the displayed contents and the functions of the function keys are displayed on a screen.
Patent Document 1: Japanese Unexamined Patent Application, Publication No. H6-238729

### DISCLOSURE OF THE INVENTION

### Problems to be Solved by the Invention

In a case where the displayed contents are changed using the function keys as described in Patent Document 1, key operation needs to be performed multiple times to display a desired graph. The key operation performed multiple times takes time. For this reason, work efficiency per time is low, and the operation is complicated. As a result, a learning cost for operation for displaying the desired graph is high. Moreover, a great number of times of operation leads to a high probability of causing an operation error. For this reason, there has been a demand for a technique of easily changing the displayed contents by the operator.

### Means for Solving the Problems

An injection molding control device according to one aspect of the present disclosure is an injection molding control device for controlling an injection molding operation of an injection molding machine, which includes a touch panel, a storage unit that stores data collected with regard to the injection molding machine, and a display control unit that displays, on the touch panel, a graph of part of the data extracted from the storage unit and changes a displayed content of the graph according to a touch operation on the touch panel. The display control unit changes the displayed content of the graph differently based on whether the touch operation is a predetermined gesture operation with a single touch or the touch operation is a gesture operation with a multi-touch.

### Effects of the Invention

According to the present disclosure, an injection molding control device allowing an operator to easily change displayed contents can be provided.

### BRIEF DESCRIPTION OF THE DRAWINGS

FIG. 1 is a block diagram showing the configuration of an injection molding control device according to one embodiment of the present disclosure;

FIG. 2 is a view showing one example of a graph displayed on the injection molding control device of FIG. 1;

FIG. 3 is a view showing an example of the graph, which is different from that of FIG. 2, displayed on the injection molding control device of FIG. 1;

FIG. 4 is a view showing an example of the graph displayed on the injection molding control device of FIG. 1 after having changed from FIG. 2;

FIG. 5 is a view showing an example of the graph, which is different from those of FIGS. 2 to 4, displayed on the injection molding control device of FIG. 1; and

FIG. 6 is a view showing an example of the graph, which is different from those of FIGS. 2 to 5, displayed on the injection molding control device of FIG. 1.

### PREFERRED MODE FOR CARRYING OUT THE INVENTION

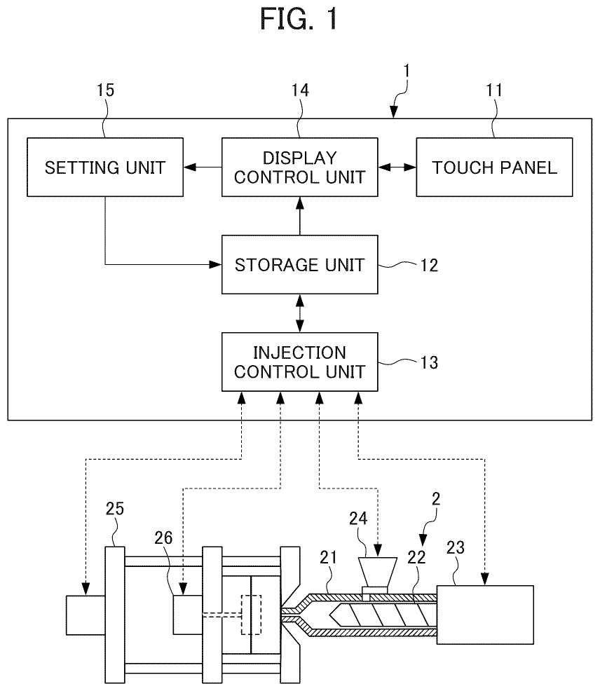

Hereinafter, an embodiment of the present disclosure will be described with reference to the drawings. FIG. 1 is a block diagram showing the configuration of an injection molding control device 1 according to one embodiment of the present disclosure.

The injection molding control device 1 controls an injection molding machine 2. The injection molding machine 2 to be controlled by the injection molding control device 1 may have a cylinder 21, a screw 22 housed in the cylinder 21, a drive unit 23 that drives the screw 22, a measuring instrument 24 that supplies resin to the cylinder 21, a mold clamping device 25 that opens and closes a mold, and an ejector 26 that ejects a molded article from the mold. Such an injection molding machine 2 is well-known, and for this reason, detailed description thereof will be omitted.

The injection molding control device 1 includes a touch panel 11, a storage unit 12, an injection control unit 13, a display control unit 14, and a setting unit 15. The injection molding control device 1 has, for example, a memory, a CPU, and an input/output interface, and may be implemented in such a manner that a computer device using the touch panel 11 as an input/output device executes an appropriate control program. The storage unit 12 may be implemented as a storage area in the memory. The injection control unit 13, the display control unit 14, and the setting unit 15 are categorized according to the function of processing performed according to the control program by the CPU, and are not necessarily clearly distinguishable in a physical structure and a program structure.

The touch panel 11 is a well-known display-input device configured such that a touch pad is arranged on the surface of a display panel. As the touch panel 11, one capable of detecting contact of a plurality of points by an operator is used.

The storage unit 12 stores, for example, the steps of an injection molding operation, a control target value, and a set value for identifying an appropriate range. Further, the storage unit 12 stores data, such as a detection value, collected with regard to the injection molding machine 2 during the injection molding operation. The data collected with regard to the injection molding machine 2 includes, for example, the pressure of injected resin (injection pressure), the temperature of the cylinder 21, the rotation speed of the screw 22, the absolute position of the screw 22, the measured torque of the measuring instrument 24, the operation position (clamp position) of the mold clamping device 25, and the operation position of the ejector 26.

The injection control unit 13 controls the injection molding operation according to a machining program. Specifically, the injection control unit 13 operates each component of the injection molding machine 2 in the order specified by the machining program, and adjusts operation of each component of the injection molding machine 2 such that a predetermined detection value matches a set value. Further, the injection control unit 13 transfers the data collected with regard to the injection molding machine 2 to the storage unit 12. Such control of the injection molding operation is well-known, and for this reason, detailed description thereof will be omitted.

The display control unit 14 displays a graph of part of data extracted from the storage unit 12 on a preset graph area of the touch panel 11, and changes the displayed content of the graph according to a touch operation on the touch panel 11.

A reference data item displayed as a first axis (generally, horizontal axis) by the display control unit 14 includes, for example, a time, a shot number, and a screw position. A data item, whose value change is observed, displayed as a second axis (generally, vertical axis) of the graph by the display control unit 14 includes, for example, an injection pressure, a rotation speed, and a measured torque.

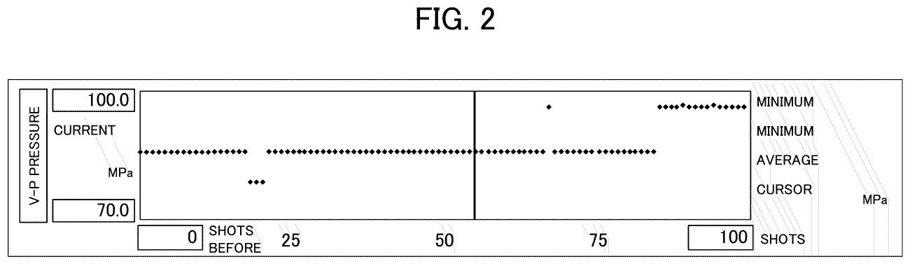

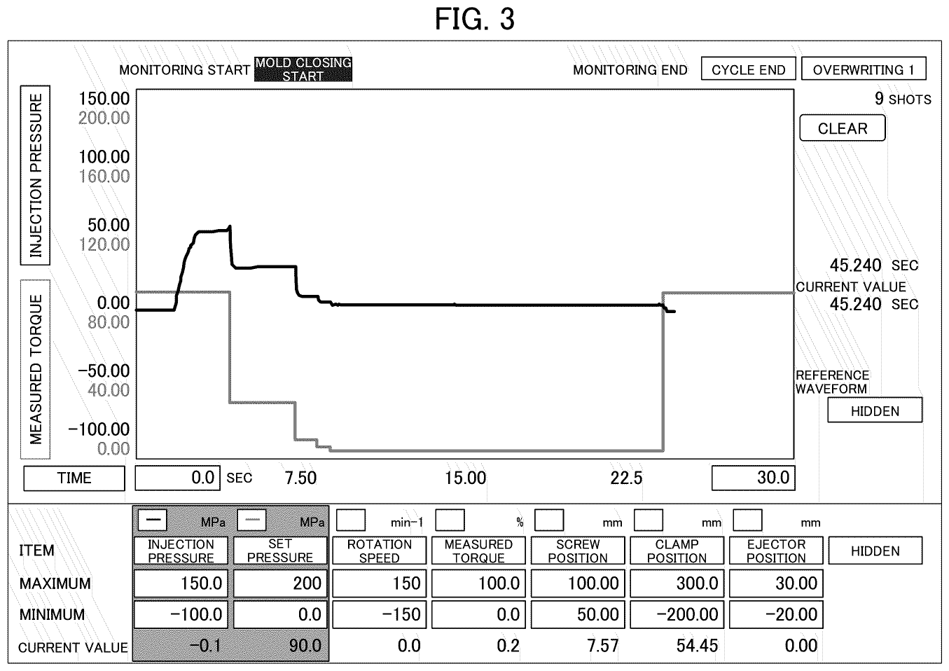

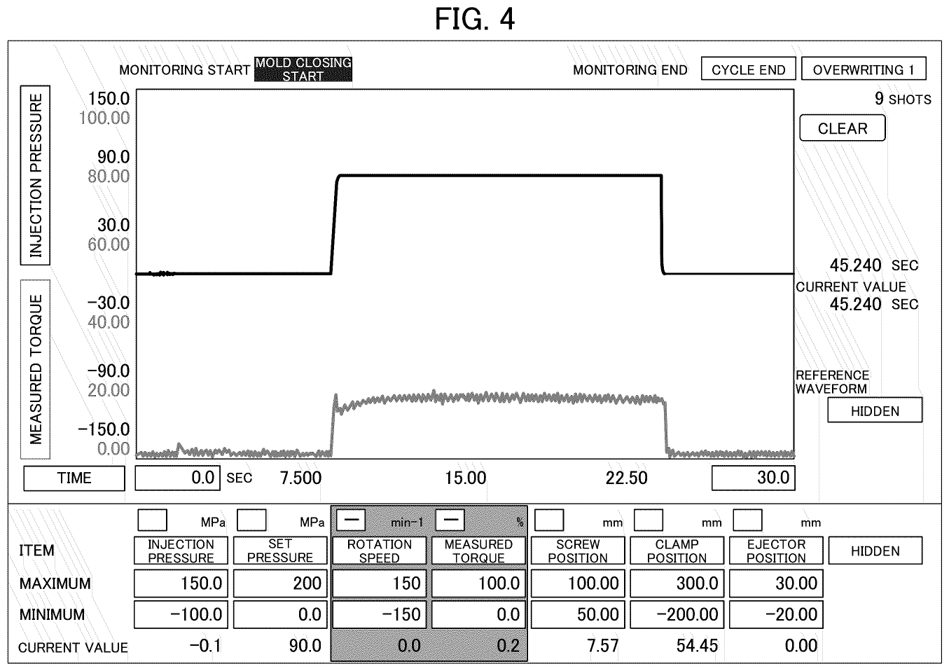

As one example of the graph displayed on the touch panel 11 by the display control unit 14, FIG. 2 shows an example of the graph in a case where the data item on the horizontal axis is a shot number and the data item on the vertical axis is a V-P switching pressure. Moreover, FIG. 3 shows an example of the graph in a case where the data item on the horizontal axis is a time and the data item on the vertical axis is a set pressure and an injection pressure, and FIG. 4 shows an example of the graph in a case where the data item on the horizontal axis is a time and the data item on the vertical axis is a measured torque and a rotation speed.

The display control unit 14 may display, on the graph, a cursor for selecting a data element (single data) on the graph or a position on the axis of the graph. In the example shown in FIG. 2, a linear cursor (search line) for selecting a point on the horizontal axis is displayed on the graph.

The display control unit 14 may be configured to display, when sensing a predetermined touch operation, a graph showing a detailed data change in the point specified by the search line in FIG. 2 in an injection molding cycle as shown in FIGS. 3 and 4. As the touch operation for changing the graph as described above, an arbitrary gesture operation with an arbitrary number of touch points, such as drag with a predetermined number of points on the cursor, may be assigned. The display control unit 14 may be configured to change the graph when detecting touch on, e.g., a not-shown switching button displayed on the touch panel 11 together with the graph of FIG. 2.

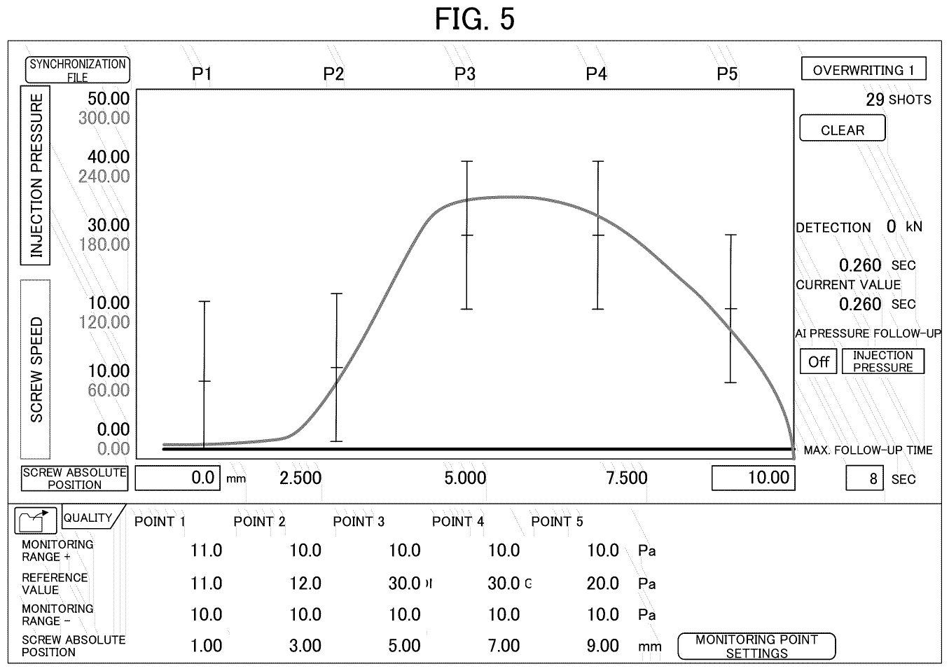

The display control unit 14 may display, on the graph, a management marker indicating an appropriate range (lower and upper limits) of the data item on the first axis. The management marker may be displayed together with a reference value (optimal value) of the data. FIG. 5 shows an example where a management marker indicating an appropriate range of an injection pressure is displayed on a graph taking a screw absolute position as the data item on the horizontal axis and taking a screw speed and the injection pressure as the data item on the vertical axis.

The displayed content of the graph changed according to the touch operation by the display control unit 14 may include at least one of movement of the range of an axis of the graph (the lower and upper limits are equally changed), a change in the scale of an axis of the graph (at least one of the lower limit or the upper limit is changed in a manner different from that of the other one), movement of the cursor for selecting the data element, or a change in the displayed data item.

The display control unit 14 changes the displayed content of the graph differently based on whether the touch operation on the touch panel 11 is a predetermined gesture operation with a single touch (touch with a single finger) or the touch operation is a gesture operation with a multi-touch (touch with a plurality of fingers). That is, the display control unit 14 determines whether the number of points (fingers) on the touch panel 11 touched by the operator is at least one or a plural number, preferably whether the number of points is a natural number of 1, 2, or 3 or more. Moreover, the display control unit 14 determines, based on, e.g., the movement speed of the touched point, whether or not the touch operation is a predetermined gesture operation including at least one of swipe, drag, or flick. Thus, the display control unit 14 determines the number of operation types obtained by multiplying the determinable number of touch points by the determinable number of gesture operations.

The display control unit 14 changes the displayed content of the graph according to the determined type of gesture operation and the determined number of touch points. The display control unit 14 may be configured to move, when sensing that a graph area is swiped, the search line on the graph in a swipe direction in the case of the single touch and to move the displayed area in parallel in the swipe direction without changing the scale of an axis of the graph in the case of the multi-touch.

When sensing that a graph area is swiped, the display control unit 14 may move the cursor (e.g., search line of FIG. 2) on the graph in a swipe direction in the case of the single touch, and may expand or reduce the scale of the axis according to the swipe direction in the case of the multi-touch. The change in the scale of the axis may include enlargement of the vertical axis by an upward multi-swipe, reduction of the vertical axis by a downward multi-swipe, enlargement of the horizontal axis by a rightward multi-swipe, reduction of the horizontal axis by a leftward multi-swipe, and enlargement or reduction of the vertical axis according to a movement amount in the up-down direction and enlargement or reduction of the horizontal axis according to a movement amount in the right-left direction by multi-swipe in an oblique direction. The display control unit 14 may be configured to move the area of the axis in parallel in a case where the multi-swipe is two-point swipe and to change the scale of the axis in a case where the multi-swipe is three-point swipe.

The display control unit 14 may move the range of an axis of the graph with inertia corresponding to an operation speed when sensing flick with the single-touch, and may move the range of an axis of the graph, for example, for each screen when sensing flick with the multi-touch. The display control unit 14 may move the range of an axis of the graph with inertia corresponding to an operation speed when sensing flick with the single touch, and may change the graph item on the vertical or horizontal axis in a predetermined order when sensing flick with the multi-touch. For example, the display control unit 14 may be configured to alternately switch the data item on the horizontal axis between a time and a screw absolute position in the case of a flick operation with two-point touch and to switch the data item on the vertical axis in a predetermined order in the case of a flick operation with three-point touch.

As a specific example, the search line may be moved in a case where a swipe operation is performed with the single touch in FIG. 2, and the graph may be moved in parallel in a case where a swipe operation is performed with the multi-touch. The display control unit 14 may be configured to move the display area of the graph with inertia corresponding to an operation speed in a case where a flick operation is performed with the single touch and to move the display area of the graph for each screen in a case where a flick operation is performed with the multi-touch. In the injection molding control device 1 configured as described above, a change in various types of data obtained in each cycle and detailed data on each cycle can be intuitively and easily checked by the gesture operation.

In FIGS. 3 and 4, many data items on the vertical axis are displayed below the graph, and two data items are plotted for one graph. In addition to the above-described operation of FIG. 2, the display control unit 14 may be configured to move two selected data items in a forward or reverse direction according to the direction of three-point flick. As described above, in the injection molding control device 1, the data item of the graph displayed on the touch panel 11 can be easily changed by the gesture operation, and therefore, the operator can easily check the data change with less data items displayed simultaneously.

The display control unit 14 may move or deform the management marker according to the gesture operation. As an example, the display control unit 14 may move the management marker of FIG. 5 in parallel by drag with the multi-touch, or may change the position of the upper or lower end of the management marker by drag of the upper or lower end of the management marker with the single touch. Further, the display control unit 14 may be configured to enlarge or reduce a management range indicated by the management marker by pinch out or pinch in.

The setting unit 15 changes a set value according to movement or deformation of the management marker by the display control unit 14. That is, in a case where the display control unit 14 moves or deforms the management marker according to the gesture operation, the setting unit 15 corrects the set value stored in the storage unit 12 to match the moved or deformed management marker. With this configuration, the operator can easily correct the set value to a more appropriate value while checking actual data on injection molding. Since the set value for the management marker can be appropriately and easily set, the efficiency of work by the operator can be enhanced, leading to reduction in a molding defect due to erroneous setting by the operator and enhancement of a production efficiency.

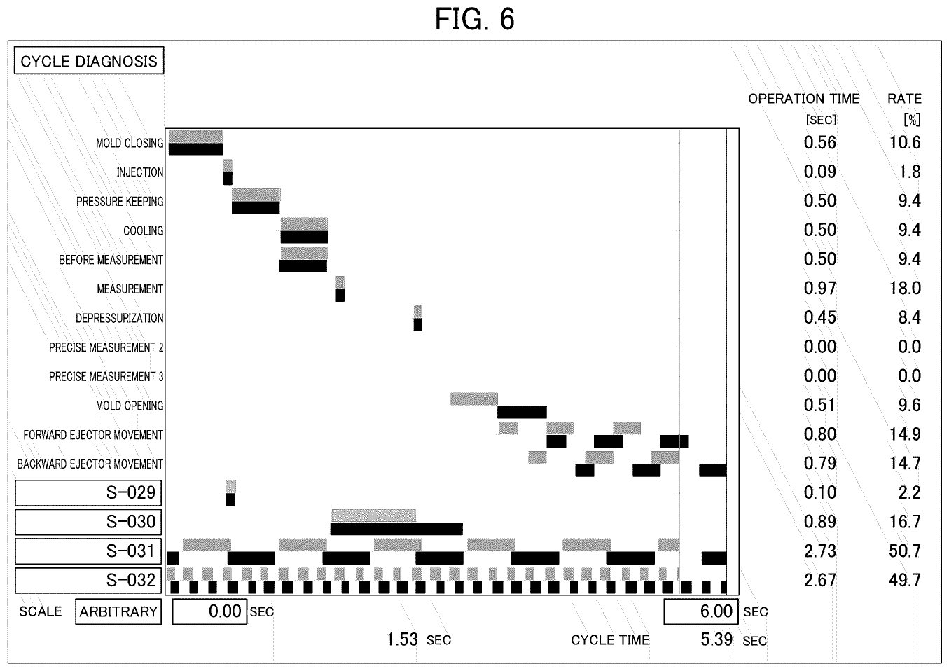

FIG. 6 shows an example where each step in one cycle, such as mold opening and injection, and the output time of each signal such as S-029 and S-030 are displayed using a bar graph. In this example, two search lines are displayed on the graph, and a time and a time rate between these search lines are displayed at the side of the graph. In a case where a swipe operation is performed on the graph of FIG. 6 with the single touch, the display control unit 14 moves each search line. The search line to be moved is selected based on whether or not the start coordinates of a drag operation match the display coordinates of any of the search lines. The display control unit 14 may be configured to move the bar graph in parallel in a case where a swipe operation is performed with the multi-touch. Operation on the graph as shown in FIG. 6 can be easily and intuitively performed according to the combination of the gesture operation and the number of touch points, and therefore, the elapsed time of each step in the cycle can be easily checked. The operator reviews molding conditions based on the checked time so that the production efficiency can be enhanced.

The setting unit 15 changes, as in the above-described case of movement or change of the management marker, an associated set value according to movement of the range of an axis of the graph, the change in the scale of an axis of the graph, and the change in the displayed data item by the display control unit 14.

According to the injection molding control device 1, when the operator performs the gesture operation such as swipe on the touch panel 11, the number of touch points is detected so that different displayed contents can be changed according to the number of touch points even in the case of the same gesture operation. For each number of touch points, the gesture operation and the displayed contents to be changed are associated with each other in one-to-one correspondence, and therefore, an injection molding machine capable of performing various types of operations without complicated operation can be provided.

In the injection molding control device 1, the displayed contents to be changed are uniquely determined according to the type of gesture operation and the number of touch points, and therefore, the operator can obtain desired displayed contents by single action. The number of times of operation can be reduced as compared to that of conventional operation using function keys, leading to reduction in time necessary for operation and an operation error. Consequently, work efficiency per time can be improved.

The gesture operation allows simpler and more-intuitive operation as compared to the operation using the function keys, and in the injection molding control device 1, a desired graph can be displayed with a lower learning cost than that of the prior art.

Further, in the injection molding control device 1, the operation for changing the displayed content of the graph can be easily and intuitively performed, and therefore, the operator can more efficiently check the data as compared to the prior art and can easily grasp the stability of molding and the state of the injection molding machine. The operator can reduce a cycle time and a molding defect by managing the molding conditions based on the checked data, and therefore, can improve the production efficiency.

The embodiment of the present disclosure has been described above, but the present invention is not limited to the above-described embodiment. The advantageous effects described above in the embodiment are merely listed as most-suitable advantageous effects of the present invention, and the advantageous effects of the present invention are not limited to those described above in the embodiment.

As an example, in the injection molding control device according to the present disclosure, the correspondence relationship between the combination of the number of touch points and the gesture operation and the displayed graph contents to be changed is not limited to that described above in the embodiment, and an arbitrary correspondence relationship may be employed.

The injection molding control device according to the present disclosure may be configured to plot many data items on the graph in, e.g., different colors and display a scale for a data item selected by the gesture operation. The injection molding control device according to the present disclosure may be configured not only to make a change by the gesture operation, but also to make a change using, e.g., a selection button similar to that of the prior art.

### EXPLANATION OF REFERENCE NUMERALS

1 Injection Molding Control Device
11 Touch Panel
12 Storage Unit
13 Injection Control Unit
14 Display Control Unit
15 Setting Unit
2 Injection Molding Machine
21 Cylinder
22 Screw
23 Drive Unit
24 Measuring Instrument
25 Mold Clamping Device
26 Ejector

1. An injection molding control device for controlling an injection molding operation of an injection molding machine, comprising:
a touch panel;
a storage unit that stores data collected with regard to the injection molding machine; and
a display control unit that displays, on the touch panel, a graph of part of the data extracted from the storage unit and changes a displayed content of the graph according to a touch operation on the touch panel,
wherein the display control unit changes the displayed content of the graph differently based on whether the touch operation is a predetermined gesture operation with a single touch or the touch operation is a gesture operation with a multi-touch.

2. The injection molding control device according to claim 1, wherein the display control unit determines, as the gesture operation, at least one of swipe, drag, or flick.

3. The injection molding control device according to claim 1, wherein a change in the displayed content by the display control unit includes at least one of movement of a range of an axis of the graph, a change in a scale of an axis of the graph, movement of a cursor for selecting a data element on the graph or a position on an axis of the graph, or a change in a data item to be displayed.

4. The injection molding control device according to claim 1, further comprising:
a setting unit that sets an appropriate range of the data in the injection molding operation,
wherein the display control unit displays, on the graph, a management marker indicating the appropriate range,
the change in the displayed content by the display control unit includes movement or deformation of the management marker, and
the setting unit changes a set value for the appropriate range according to the movement or deformation of the management marker.
